(19) United States
(12) Patent Application Publication
(10) Pub. No.: US 2016/0054877 A1
(43) Pub. Date: Feb. 25, 2016

(54) COMMUNICATION ADAPTER, AND PROGRAM

(71) Applicant: MITSUBISHI ELECTRIC CORPORATION, Tokyo (JP)

(72) Inventor: Takahiro ITO, Tokyo (JP)

(73) Assignee: Mitsubishi Electric Corporation, Tokyo (JP)

(21) Appl. No.: 14/781,055

(22) PCT Filed: Apr. 10, 2013
(86) PCT No.: PCT/JP2013/060799

§ 371 Date: Sep. 29, 2015

(51) Int. Cl. G06F 3/0484

(52) U.S. Cl. CPC G06F 3/0484

(57) ABSTRACT

A communication adapter acquires, upon receiving a screen acquisition request from a terminal device via a network, screen data of a requested screen, and transmits the acquired screen data to the terminal device. At this time, the communication adapter identifies at least one next screen that can follow the requested screen, with reference to screen transition data. The communication adapter then acquires screen data of the specified next screen from an air-conditioning controller via a serial cable, and stores the acquired data.

### TECHNICAL FIELD

The present disclosure relates to a communication adapter for connecting a device to a network and a program.

### BACKGROUND ART

Technology is known for connecting a communication adapter to a device without a function of connecting to a network such as the Internet, and for enabling remote operation from a personal computer (PC) and the like. For example, Patent Literature 1 discloses connecting a communication adapter to a household-related device such as household equipment, household electrical appliance, healthcare device, sensor device, and the like, and remotely operating the household-related device from a Web browser of a PC via a network, and acquiring status information.

### CITATION LIST

### Patent Literature

Patent literature 1: Unexamined Japanese Patent Application Kokai Publication No. 2007-122557

### SUMMARY OF INVENTION

### Technical Problem

Here, the case of connecting the above mentioned communication adapter to an air-conditioning controller or the like with a comparatively large number of operation screens to remotely control the air-conditioning controller from a PC is considered. In this case, the air-conditioning controller is required to transmit screen data for a requested operation screen to the PC via the communication adapter. However, when the necessary screen data is transmitted from the air-conditioning controller to the PC each time a request from the PC is made, there is a possibility that the communication between the air-conditioning controller and the communication adapter becomes a bottleneck, thereby reducing the overall communication speed.

One possible option to reduce the communication load between the air-conditioning controller and the communication adapter is to previously store, in the communication adapter, the screen data stored in the air-conditioning controller for all the screens. However, since a large amount of screen data is typically stored in the air-conditioning controller, storing all of the screen data in the communication adapter increases memory capacity requirements, which may incur additional costs.

The present disclosure is made in view of the situation as described above, and an objective of the present disclosure is to provide a communication adapter and a program that are capable of quickly responding to a screen display request while saving a memory capacity.

### Solution to Problem

To achieve the above objective, the communication adapter of the present disclosure, which is connected to a first device and is connected to a second device via a network, includes:

screen transition data storage means for storing screen transition data that indicates a transition between screens for which screen data is stored in the first device; screen data transmission means for acquiring, upon reception of an acquisition request for a screen from the second device, screen data of the screen requested in the acquisition request, and transmitting the screen data to the second device;

acquisition screen identification means for identifying, upon reception of an acquisition request for a screen from the second device, at least one next screen as an acquisition screen with reference to the screen transition data, the next screen being a next candidate that follows the screen requested in the acquisition request; and screen storage means for acquiring, from the first device, screen data of the acquisition screen identified by the acquisition screen identification means, and storing the screen data.

### Advantageous Effects of Invention

With the technology of the present disclosure, it is possible to immediately respond to a screen display request while saving memory capacity.

### BRIEF DESCRIPTION OF DRAWINGS

FIG. 1 illustrates the construction of a communication system of an embodiment of the present disclosure;

FIG. 2 is a block diagram illustrating the construction of a communication adapter;

FIG. 3 illustrates an example of screen transition data;

FIG. 4 illustrates an example of transitions between screens;

FIG. 5 is a block diagram illustrating the construction of an air-conditioning controller;

FIG. 6 is a flowchart for explaining the operation of an initial connection process;

FIG. 7 is a flowchart for explaining the operation of a request receiving time process;

FIG. 8 is a flowchart for explaining the operation of a screen acquisition and transmission process;

FIG. 9 illustrates an example of a screen acquisition request command;

FIG. 10 illustrates an example of a response message;

FIG. 11 is a flowchart for explaining the operation of a remote operation process;

FIG. 12 illustrates an example of an operation request;

FIG. 13 illustrates an example of a response message; and

FIG. 14 illustrates an example of screen transition data.

### DESCRIPTION OF EMBODIMENTS

Embodiments of the present disclosure are described hereinafter with reference to the drawings. The same reference signs denote the same or corresponding portions throughout the drawings.

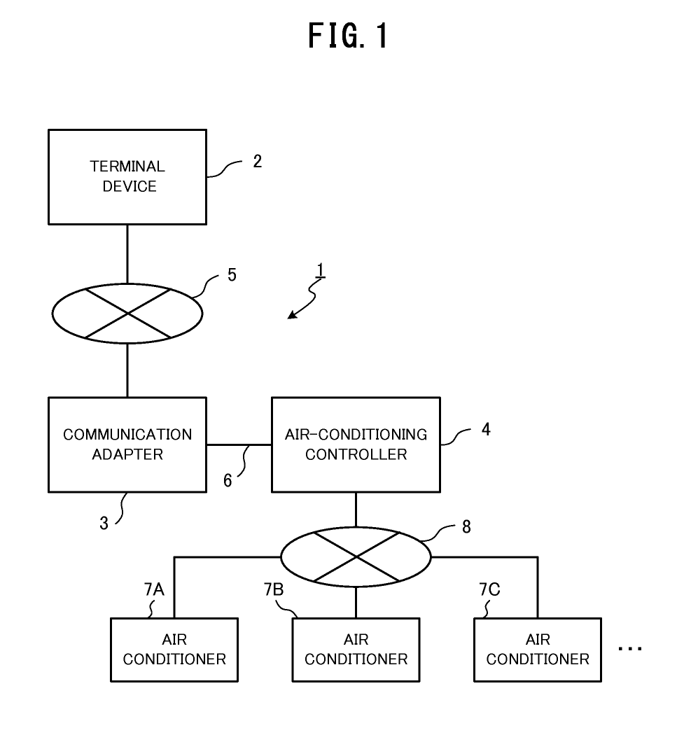

A network system 1 of an embodiment of the present disclosure will described with reference to FIG. 1. The network system 1 includes a terminal device 2 (second device), a communication adapter 3, and an air-conditioning controller 4 (first device). The terminal device 2 and the communication adapter 3 are communicatively connected to each other via a network 5 such as the Internet. Moreover, the communication adapter 3 and the air-conditioning controller 4 are communicatively connected to each other via a serial cable 6.

The terminal device 2, for example, is a PC, a smart phone, or the like, and includes an input device such as a keyboard or a mouse, a display device such as a display, a communication interface and a Web browser for connecting to, the network 5, or the like. The terminal device 2 is a device for remotely managing or operating an air-conditioning controller 4, and sends a request for screen data or operation to the communication adapter 3 via the network 5. Moreover, the terminal device 2 receives screen data used for operating the air-conditioning controller 4 from the communication adapter 3 via the network 5.

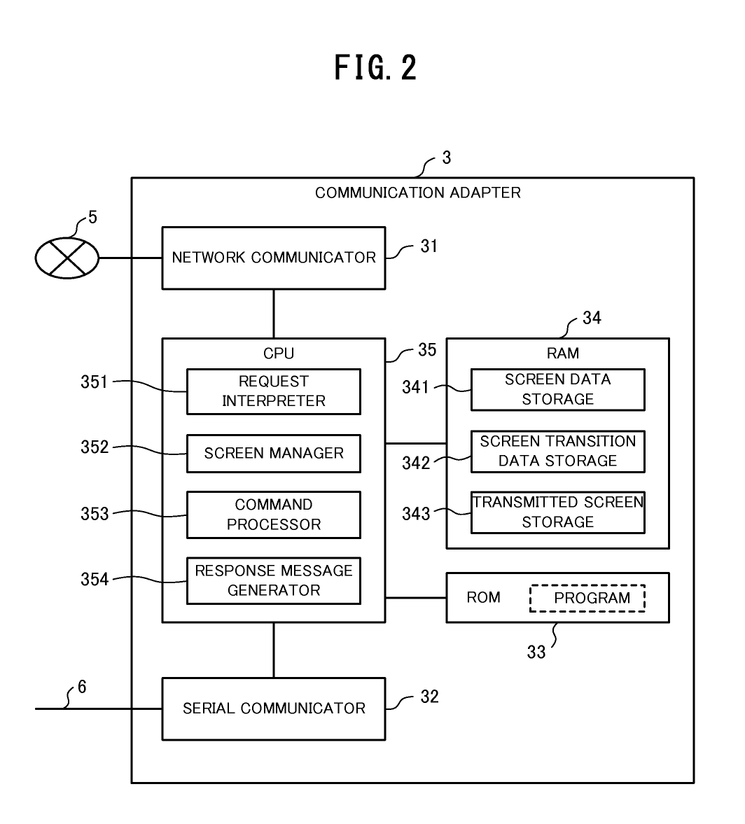

The communication adapter 3 is a device for connecting the air-conditioning controller 4, which is connected via by way of the serial cable 6, to the network 5. The communication adapter 3 includes, as illustrated in FIG. 2, a network communicator 31, a serial communicator 32, a read only memory (ROM) 33, a random access memory (RAM) 34, and a central processing unit (CPU) 35.

The network communicator 31 includes a communication interface for connecting to the network 5, and under the control of the CPU 35, performs data communication with the terminal device 2 via the network 5. The serial communicator 32 includes a connector or the like for connecting to the serial cable 6, and under the control of the CPU 35, performs data communication (serial communication) with the air-conditioning controller 4 via the serial cable 6.

The ROM 33 stores a program to be executed by the CPU 35, and various kinds of fixed data.

The RAM 34 is used as a work area for the CPU 35. Moreover, the RAM 34 includes a screen data storage 341, a screen transition data storage 342, and a transmitted screen storage 343.

Screen data for part of the screens of the air-conditioning controller 4, acquired from the air-conditioning controller 4, is stored in the screen data storage 341. The screen data is data that includes HTML files or applets (class files) that are read by a Web browser, image data that is embedded in a screen, and the like.

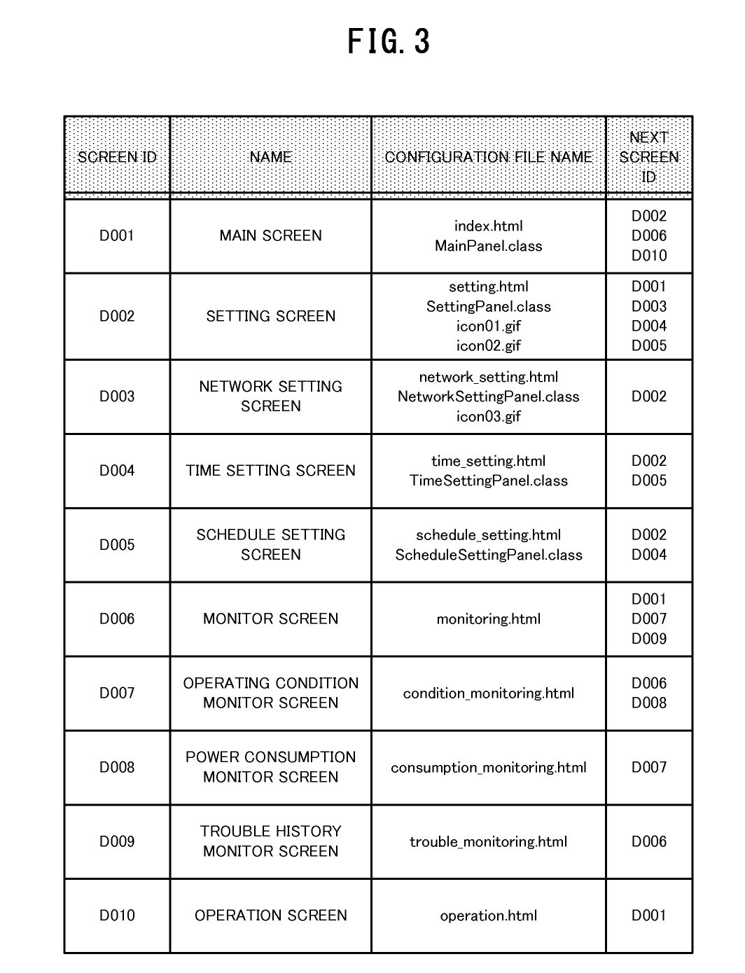

Screen transition data that indicates the transition between screens of the air-conditioning controller 4 is stored in the screen transition data storage 342. For example, the screen transition data is tabular data, as illustrated in FIG. 3, which includes a screen ID, a name, a configuration file name, a next screen ID, and the like for each screen.

The screen ID is an ID applied for uniquely identifying a screen. The name indicates a role of a screen and the like. The configuration file name is a file name of screen data that constitutes a screen (HTML file, applet, image data, and the like). A next screen ID indicates the screen ID of a screen that can be a next following candidate (next screen) by a user performing a specified operation on a screen using a mouse, keyboard, and the like.

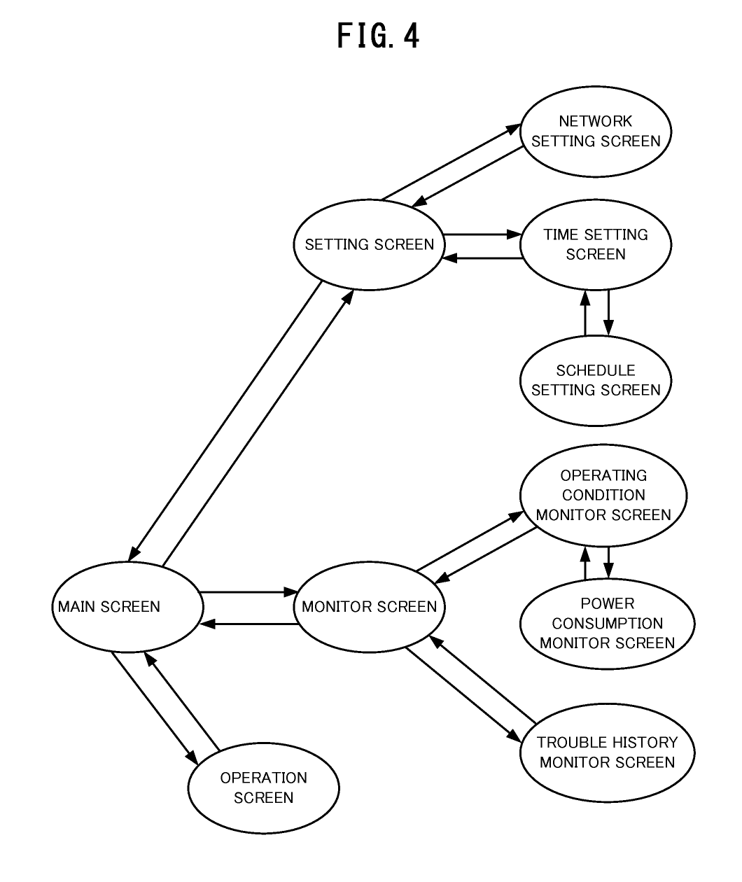

The screen transition data illustrated in FIG. 3 shows, for example, that a transition is possible from the main screen to a setting screen, a monitor screen, and an operation screen respectively having screen IDs “D002”, “D006” and “D010.” As can been seen, the screen transition data illustrated in FIG. 3 can be depicted as screen transitions as illustrated in FIG. 4.

Returning to FIG. 2, transmitted screen information that indicates screen data that has already been transmitted to the terminal device 2 is stored in the transmitted screen storage 343. The transmitted screen information is expressed, for example, as a screen ID for the screen data that has already been transmitted to the terminal device 2.

The CPU 35 controls the overall communication adapter 3 by executing a program stored in the ROM 33. Moreover, the CPU 35 functionally includes a request interpreter 351, a screen manager 352, a command processor 353, and a response message generator 354.

The request interpreter 351 determines whether a request from the terminal device 2 is a request to acquire screen data, or a request to perform an operation to the air-conditioning controller 4.

The screen manager 352 acquires, from the RAM 34 or the air-conditioning controller 4, screen data that is requested from the terminal device 2. Moreover, the screen manager 352 acquires, from the air-conditioning controller 4, screen data of at least one next screen that can follow the screen that is indicated by the screen data requested from the terminal device 2, and stores the screen data in the screen data storage 341. The processing performed by the screen manager 352 will be described in detail below.

The response message generator 354 creates a response message for transmitting screen data acquired by the screen manager 352 to the terminal device 2. Moreover, the response message generator 354 generates a response message for transmitting the results of a remote operation of the air-conditioning controller 4 to the terminal device 2.

The command processor 353 creates an operation command for operating the air-conditioning controller 4 according to a request from the terminal device 2, and transmits the command to the air-conditioning controller 4. The processing performed by the command processor 353 will be described in detail below.

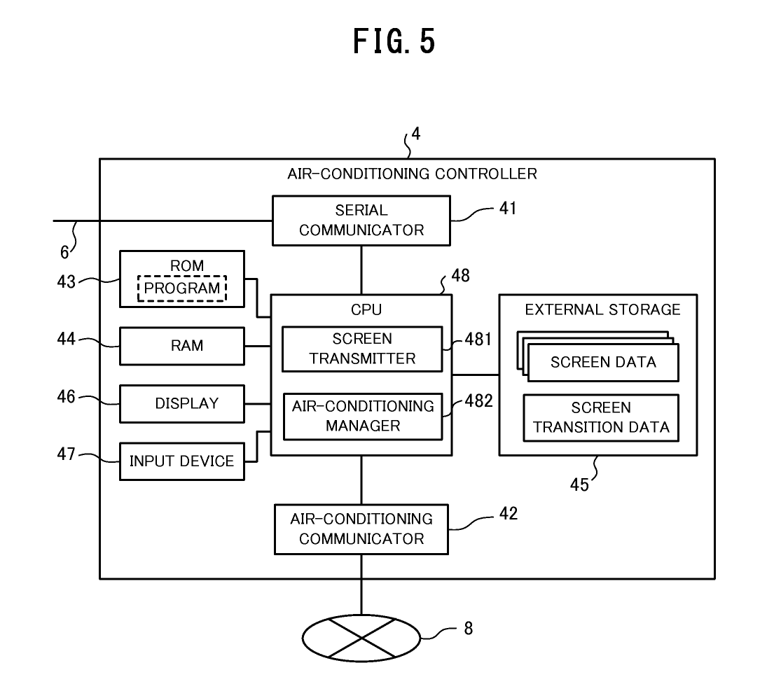

Returning to FIG. 1, the air-conditioning controller 4 monitors and controls each of air conditioners 7A, 7B, 7C, and so on via an air-conditioning network 8. The air-conditioning controller 4, as illustrated in FIG. 5, includes a serial communicator 41, an air-conditioning communicator 42, a ROM 43, a RAM 44, an external storage 45, a display 46, an input device 47, and a CPU 48.

The serial communicator 41 includes a communication interface for connecting to the serial cable 6, and under the control of the CPU 48, performs data communication (serial communication) with the communication adapter 3 via the serial cable 6. The air-conditioning communicator 42 is, for example, configured to include a communication interface such as a LAN card or the like, and is communicatively connected to the air-conditioning network 8, and under the control of the CPU 48, performs data communication with each of the air conditioners 7 via the air-conditioning network 8.

The ROM 43 stores a program for the CPU 48 to execute, and various kinds of fixed data, and the like. The RAM 44 is used as a work area for the CPU 48, and temporarily stores various kinds of data.

The external storage 45 serves as a so-called secondary storage (auxiliary storage), and for example, includes a readable and writable non-volatile semiconductor memory such as a flash memory. Moreover, the external storage 45 stores screen data for all of the necessary screens for the air-conditioning controller 4 to manage the air conditioners 7. Furthermore, the external storage 45 stores the screen transition data as described above.

The display 46 comprises a liquid-crystal display or the like, and under the control of the CPU 48, displays screens based on screen data that is stored in the external storage 45.

The input device 47 comprises a touch panel, a touch pad, or the like, and receives an operation input from a user. For example, the input device 47 receives, from a user, operations (button clicks and the like) for screens displayed on the display 46.

The CPU 48 controls the overall air-conditioning controller 4 by executing a program stored in the ROM 43. Moreover, the CPU 48 functionally includes a screen transmitter 481 and an air-conditioning manager 482.

The screen transmitter 481 controls the serial communicator 41 to transmit, to the communication adapter 3, screen data or screen transition data requested by the communication adapter 3.

The air-conditioning manager 482 controls the operation of the air conditioners 7 or acquires status information from the air conditioners 7, according to instructions that are input by a user by means of the input device 47 or operation commands that are instructed by the terminal device 2 via the communication adapter 3.

Next, the processing operation performed by the CPU 35 of the communication adapter 3 in the network system 1 configured as described above will be described.

(Initial Connection Process)

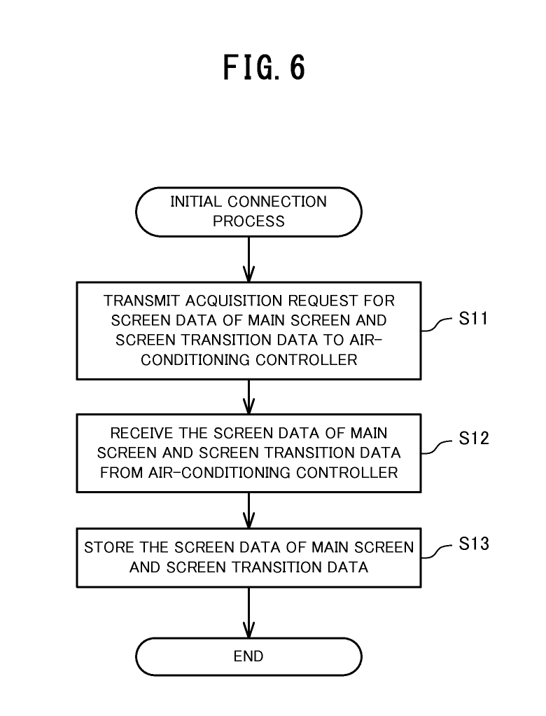

To begin with, the initial connection process will be described with reference to the flowchart in FIG. 6. The initial connection process is a process that is performed when the communication adapter 3 is initially connected to the air-conditioning controller 4 using the serial cable 6.

First, the screen manager 352 of the communication adapter 3 controls the serial communicator 32 to transmit, to the air-conditioning controller 4, an acquisition request for the screen data of the screen initially displayed (main screen) when the air-conditioning controller 4 is operated, and for the screen transition data (step S11). After receiving this acquisition request, the screen transmitter 481 of the air-conditioning controller 4 acquires the requested screen data for the main screen and the requested screen transition data from the external storage 45. Then, the screen transmitter 481 controls the serial communicator 41 to transmit the acquired screen data for the main screen and the acquired screen transition data to the communication adapter 3. It is assumed that information that indicates which screen data of the plurality of pieces of screen data stored in the external storage 45 is for the main screen is previously stored in the ROM 43 or the external storage 45 of the air-conditioning controller 4.

After receiving the screen data for the main screen and the screen transition data from the air-conditioning controller 4 (step S12), the screen manager 352 stores the received data in the respective screen data storage 341 and screen transition data storage 342 (step S13). The initial connection process then ends.

(Request Receiving Time Process)

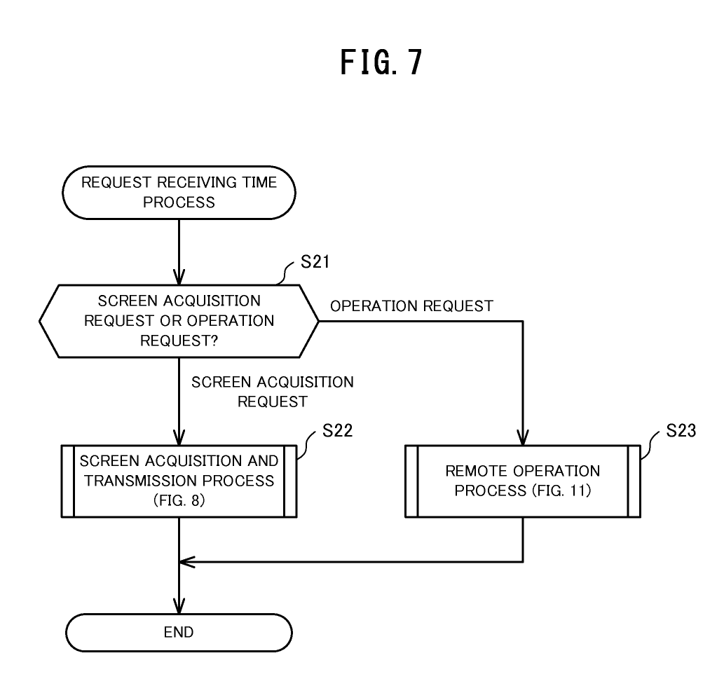

Next, the request receiving time process performed by the communication adapter 3 will be described with reference to the flowchart in FIG. 7. The request receiving time process is a process that is performed when a request from the terminal device 2 (HTTP request) is received.

First, the request interpreter 351 analyzes the received request, and determines whether the request is a screen acquisition request for requesting the acquisition of screen data or an operation request for requesting operation for air conditioners 7 (step S21).

When the received request is a screen acquisition request (step S21: screen acquisition request), the screen manager 352 of the communication adapter 3 acquires the requested screen data and transmits the screen data to the requesting terminal device 2, and also executes the screen acquisition and transmission process for acquiring screen data for the next screen from the air-conditioning controller 4 and storing the screen data (step S22). The request receiving time process then ends.

On the other hand, when the received request is an operation request (step S21: operation request), the command processor 353 of the communication adapter 3 creates an operation command that corresponds to the requested operation, and then transmits that command to the air-conditioning controller 4 and executes a remote operation process for remotely operating the air-conditioning controller 4 (step S23). The request receiving time process then ends.

(Screen Acquisition and Transmission Process)

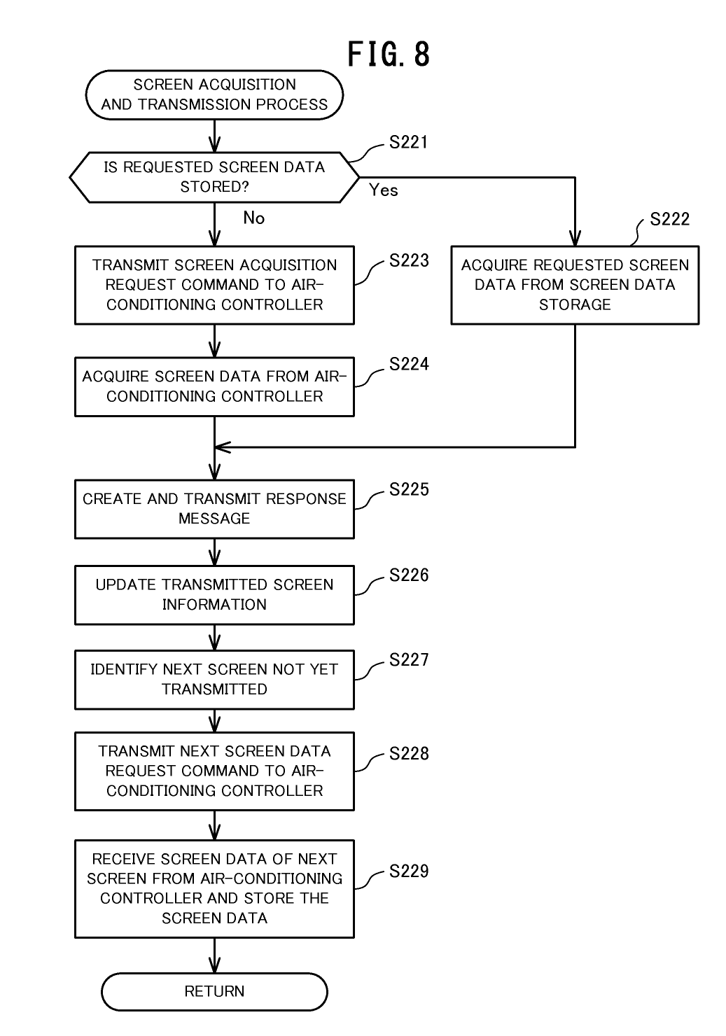

Next, the screen acquisition and transmission process described above (FIG. 7, step S22) will be described in detail with reference to the flowchart in FIG. 8.

First, the screen manager 352 of the communication adapter 3 determines whether or not the screen data requested by the received screen acquisition request is stored in the screen data storage 341 (step S221).

When the screen manager 352 determines that the screen data is stored in the screen data storage 341 (step S221: YES), the screen manager 352 acquires the requested screen data from the screen data storage 341 (step S222).

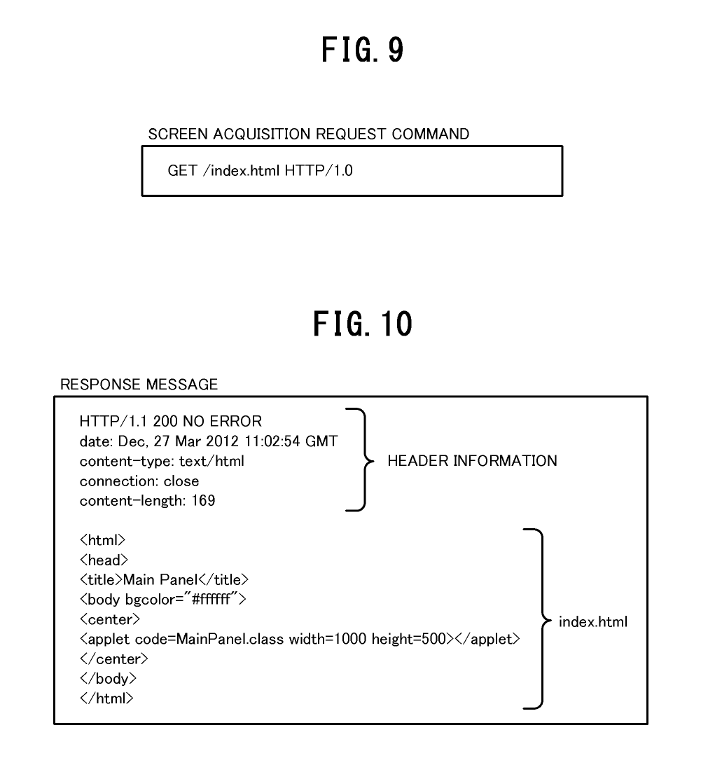

On the other hand, when the screen manager 352 determines that the screen data is not stored in the screen data storage 341 (step S221: NO), the screen manager 352 creates a screen acquisition request command as illustrated in FIG. 9 for requesting the screen data, and then controls the serial communicator 32 to transmit the command to the air-conditioning controller 4 (step S223). FIG. 9 illustrates a command for requesting the HTML file “index.html”.

The screen transmitter 481 of the air-conditioning controller 4 acquires from the external storage 45 the screen data that is requested by the screen acquisition request command received from the communication adapter 3, and transmits that screen data to the communication adapter 3. For example, when the HTML file “index.html” is requested by a screen acquisition request command, the screen transmitter 481 acquires “index.html” and applets and image data, which are invoked from the “index.html”, from the external storage 45 as the requested screen data, and transmits the acquired data to the communication adapter 3.

Returning to FIG. 8, upon acquiring the screen data from the air-conditioning controller 4 (step S224), or upon acquiring the screen data from the screen data storage 341 (step S222), the screen manager 352 of the communication adapter 3 controls the response message generator 354 to create a response message for transmitting the acquired screen data to the terminal device 2 and to transmit the screen data to the terminal device 2 requesting the acquisition of the screen data (step S225). More specifically, as illustrated in FIG. 10, the screen manager 352 creates a response message by controlling the response message generator 354 to add specified header information to the HTML file that is included in the acquired screen data. In this example, a response message is created in which header information is added to the HTML file “index.html”.

In the terminal device 2, the HTML file in the received response message is analyzed by the Web browser, and a screen corresponding to the analysis results (in other words, the requested screen) is displayed on a display not illustrated in the figure. At this time, when there is an applet, an image file, and/or the like to be invoked from the displayed HTML file, the terminal device 2 transmits an acquisition request therefor to the communication adapter 3 and acquires the applet, the image file, and/or the like. For example, when receiving the response message illustrated in FIG. 10, the terminal device 2 transmits, to the communication adapter 3, an acquisition request for the applet “MainPanel.class” invoked from “index.html”, and acquires the applet.

Returning to FIG. 8, after transmitting a response message, the screen manager 352 of the communication adapter 3 updates the transmitted screen information that is stored in the transmitted screen storage 343 (step S226). More specifically, the screen manager 352 additionally registers, in the transmitted screen information, the screen ID of the transmitted screen data that is included in the response message.

Next, the screen manager 352 references the screen transition data that is stored in the screen transition data storage 342 and the transmitted screen information that is stored in the transmitted screen storage 343, and identifies at least one next screen that can follow the screen requested by the terminal device 2 and for which the screen data has yet to be transmitted to the terminal device 2 (step S227).

Then, the screen manager 352 creates a next screen data request command for requesting the screen data for the at least one next screen identified in step S227, and then controls the serial communicator 32 to transmit the command to the air-conditioning controller 4 (step S228).

The screen transmitter 481 of the air-conditioning controller 4 acquires the screen data for the requested next screen from the external storage 45 based on the next screen data request command received from the communication adapter 3, and transmits the data to the communication adapter 3.

After receiving the screen data for the at least one next screen from the air-conditioning controller 4, the screen manager 352 of the communication adapter 3 stores the screen data in the screen data storage 341 (step S229). When there is insufficient free space in the screen data storage 341, the screen manager 352 makes the space by deleting screen data in chronological order by storage date until sufficient free space is available. The screen acquisition and transmission process then ends.

(Remote Operation Process)

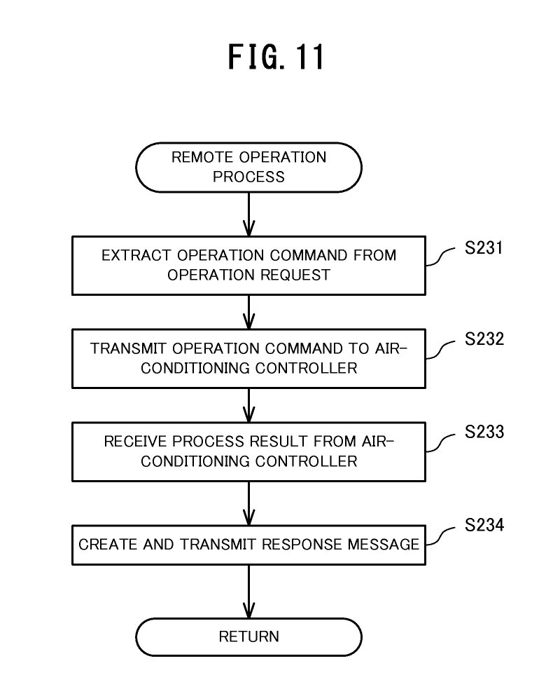

Next, the above-mentioned remote operation process (step S23 in FIG. 7) will be described in detail with reference to the flowchart in FIG. 11.

First, the command processor 353 of the communication adapter 3 analyzes the received operation request and extracts an operation command for operating an air conditioner 7 (step S231).

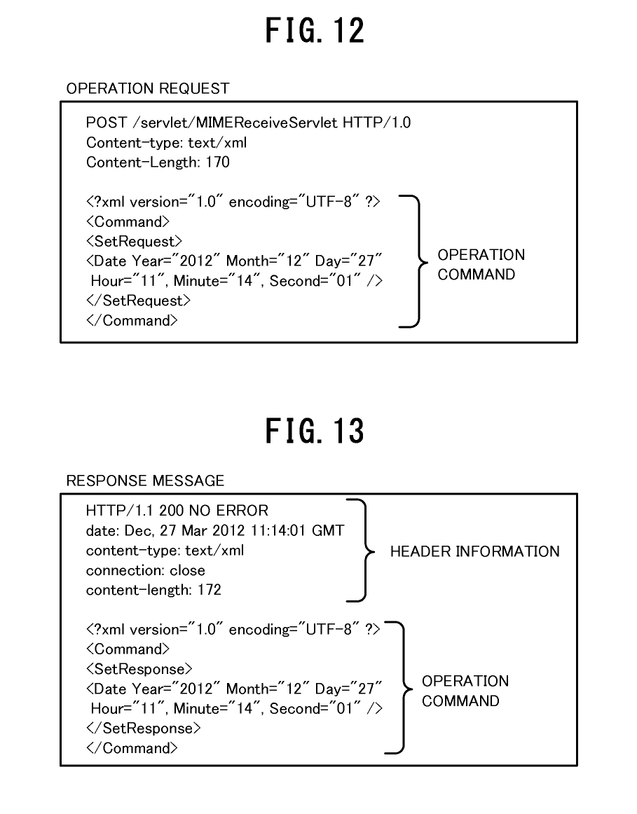

For example, when receiving an operation request as illustrated in FIG. 12, the command processor 353 may extract as the operation command only a portion specified by a command tag.

Returning to FIG. 11, the command processor 353 controls the serial communicator 32 to transmit the extracted operation command to the air-conditioning controller 4 (step S232).

The air-conditioning manager 482 of the air-conditioning controller 4 executes processing based on the received operation command. Then, the air-conditioning manager 482 transmits process result information that indicates the results of the executed processing (information that indicates whether the processing has been executed or ended in error) to the communication adapter 3. After receiving the process result information (step S233), the command processor 353 controls the response message generator 354 to create a response message for notification of the process results and to transmit the response message to the terminal device 2 that is the transmission source (step S234). More specifically, as illustrated in FIG. 13, the command processor 353 controls the response message generator 354 to create a response message by adding, to the operation command extracted in step S231, header information that indicates the results of processing based on the operation command. The response message illustrated in FIG. 13 is a response message that indicates the process execution without any error. The remote operation process then ends.

Thus, according to this embodiment, the communication adapter 3 transmits screen data of a screen requested by the terminal device 2, and acquires, from the air-conditioning controller 4, screen data for the at least one next screen that can follow the requested screen and stores the screen data. Therefore, the next screen data, which is to be requested from the terminal device 2, is already stored in the communication adapter 3. This embodiment thus enables the screen data requested from the terminal device 2 to be immediately acquired from the communication adapter 3 without downloading of the data from the air-conditioning controller 4, and enables an immediate response to a request for displaying a screen. This embodiment also enables saving in memory capacity because the communication adapter 3 is only required to store at least screen data for the next screen.

Typically, screen data for a screen displayed by the terminal device 2 is stored in a cache of the Web browser. When displaying this screen again, the terminal device 2 is thus not required to request the communication adapter 3 to acquire the screen data for this screen. Accordingly, in this embodiment, when the screen data for the at least one next screen has already been transmitted to the terminal device 2, the communication adapter 3 does not perform processing of acquiring the screen data from the air-conditioning controller 4 and storing the screen data, even though the screen data is for the next screen. Therefore, with the technology of the present disclosure, it is possible to avoid unnecessary communication and to save more memory capacity of the communication adapter 3.

When the activated Web browser is terminated (OFF), the data that has been stored in the cache is typically cleared, and a request for the screen data that has already been transmitted is required to be resent to the communication adapter 3. Therefore, when the screen manager 352 has not received a screen acquisition request from the terminal device 2 for at least a specified amount of time, the screen manager 352 can determine that the Web browser has been terminated by the terminal device 2, and update the transmitted information stored in the transmitted screen storage 343 to information indicating that there is no screen data that has already been transmitted in the terminal device 2. This can shorten the time for acquiring screen data even when the cache is cleared and screen data is requested again.

The present disclosure is not limited to the embodiments above, and various changes within the scope of the present disclosure are of course possible.

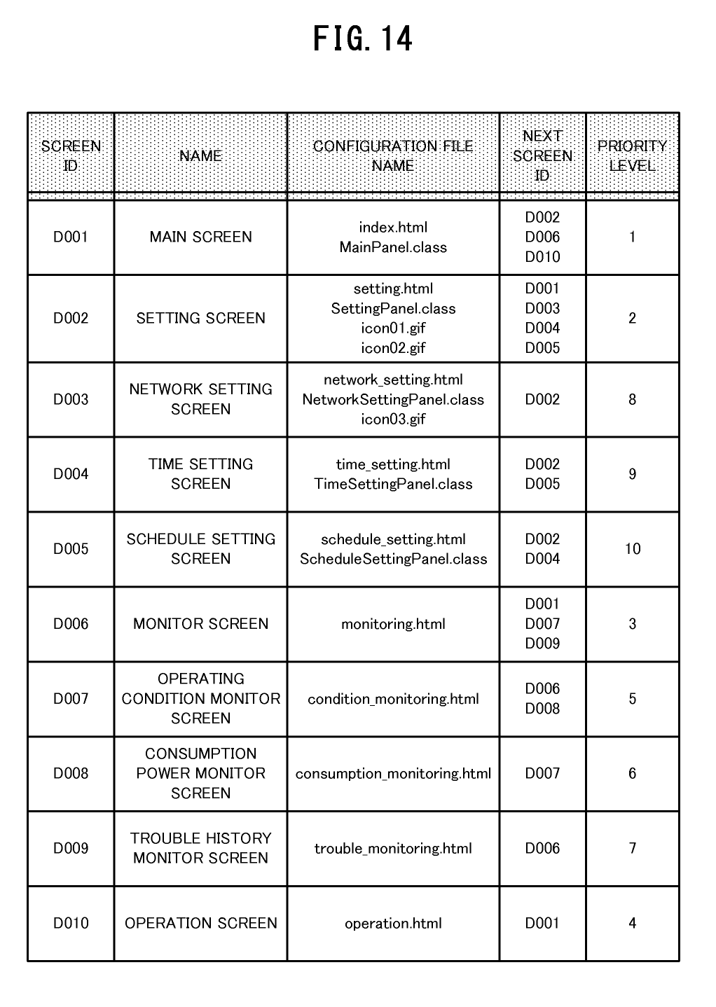

For example, as illustrated in FIG. 14, a priority level can be stored for each screen in the screen transition data that is stored in the screen transition data storage 342 of the communication adapter 3. This priority level is preferably set based on how frequently the screen is displayed. Then, when multiple next screens for which screen data has yet to be transmitted to the terminal device 2 are identified in step S227 of the screen acquisition and transmission process illustrated in FIG. 8, the screen manager 352 can perform processing for preferentially acquiring, from the air-conditioning controller 4, screen data of the next screen in descending order of the priority level and storing the screen data (steps S228 and S229). This can prevent a decrease in the display speed when the screen with the high priority level is displayed and thus provide comfortable viewing because the screen data for the screen with the high priority level is preferentially stored in the screen data storage 341 even when there is not enough storage capacity in the RAM 34 so that all the screen data for the at least one next screen identified in step S227 cannot be stored in the screen data storage 341.

Moreover, although the communication adapter 3 as described in the embodiments above is connected to the air-conditioning controller 4, the technology of the present disclosure can also be suitably applied to all communication adapters, which are connected to devices that store a plurality of pieces of screen data or external storage devices, for example, a flash memory.

In step S227 of the screen acquisition and transmission process illustrated in FIG. 8, all of the at least one next screen for a screen requested by the terminal device 2 can be identified regardless of whether or not screen data has been transmitted to the terminal device 2.

Moreover, the technology of the present disclosure can also be similarly applied to a system that includes a plurality of terminal devices 2. In this case, it is necessary to identify at least one next screen for a requested screen, acquire the screen data from the air-conditioning controller 4, and store the screen data in the screen data storage 341, for each terminal device 2. When there is the same next screen among terminal devices 2, the only one screen data thereof is preferably stored in the screen data storage 341 in order to save memory capacity of the RAM 34. Moreover, when there is a terminal device 2 that has not received a screen acquisition request for at least a specified amount of time, it is possible to determine that operation of this terminal device 2 is finished, and then delete the screen data for the at least one next screen that correspond to this terminal device 2 from the screen data storage 341, so as not to reduce the storage area of the RAM 34.

Moreover, although the communication adapter 3 in the embodiments above acquires screen transition data from the air-conditioning controller 4, how the screen transition data is acquired is freely selected. For example, the data can be screen transition data inputted by a user.

Furthermore, in the embodiments above, by applying programs executed by the communication adapter 3 to an existing computer or the like, it is possible that the computer or the like serve as the communication adapter according to the present disclosure.

The method for distributing such programs is freely selected; for example, the programs can be stored and distributed on a non-transitory computer-readable recording medium such as a compact disk read-only memory (CD-ROM), a digital versatile disk (DVD), a magneto optical disk (MO), a memory card, and the like, or can be distributed via a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The technology of the present disclosure can be preferably applied to a communication adapter for connecting a device that stores a plurality of pieces of screen data to a network.

### REFERENCE SIGNS LIST

1 Network system
2 Terminal device
3 Communication adapter
4 Air-conditioning controller

### 5 Network

6 Serial cable
7 Air conditioner
8 Air-conditioning network
31 Network communicator
32, 41 Serial communicator

### 33, 43 ROM

### 34, 44 RAM

### 35, 48 CPU

341 Screen data storage
342 Screen transition data storage
343 Transmitted screen storage
351 Request interpreter
352 Screen manager
353 Command processor
354 Response message generator
42 Air-conditioning communicator
45 External storage

### 46 Display

47 Input device
481 Screen transmitter
482 Air-conditioning manager

1. A communication adapter for connection to a first device and for connection to a second device via a network, the communication adapter comprising:
a screen data transmitter configured to acquire, upon reception of an acquisition request for a screen from the second device, screen data of the screen requested in the acquisition request, and transmit the screen data to the second device; and
a screen storage configured to acquire,
upon reception of the acquisition request, screen data of at least one next screen from the first device, and store the screen data, the at least one next screen being a next candidate that follows the screen requested in the acquisition request, the screen data being data that has yet to be transmitted to the second device, or
upon reception of the acquisition request after a specified amount of time has elapsed from an immediately preceding acquisition request, screen data of all the at least one next screen from the device, and store the screen data.

2-3. (canceled)

4. The communication adapter according to claim 1, further comprising:
a screen priority level storage configured to store a priority level for each screen for which screen data is stored in the first device; wherein
the screen storage is configured to acquire screen data of the at least one next screen in descending order of the priority level, and store the screen data.

5. A non-transitory computer-readable recording medium storing a program that causes a computer for connection to a first device and for connection to a second device via a network to function as:
a screen data transmitter configured to acquire, upon reception of an acquisition request for a screen from the second device, screen data of a screen requested in the acquisition request, and transmit the screen data to the second device;
a screen storage configured to acquire,
upon reception of the acquisition request, screen data of at least one next screen from the first device, and store the screen data, the at least one next screen being a next candidate that follows the screen requested in the acquisition request, the screen data being data that has yet to be transmitted to the second device, or
upon reception of the acquisition request after a specified amount of time has elapsed from an immediately preceding acquisition request, screen data of all the at least one next screen from the device, and store the screen data.
